(19) United States
(12) Patent Application Publication
(10) Pub. No.: US 2022/0065009 A1
(43) Pub. Date: Mar. 3, 2022

(54) TEMPORARY STRIKE PLATE WITH LOCKING FEATURES

(71) Applicant: NEOPOD SYSTEMS LLC, New Braunfels, TX (US)

(72) Inventors: Juan Bermudez, New Braunfels, TX (US); Michael Miller, New Braunfels, TX (US)

(73) Assignee: NEOPOD SYSTEMS LLC

(21) Appl. No.: 17/461,801

(22) Filed: Aug. 30, 2021

Related U.S. Application Data
(60) Provisional application No. 63/072,658, filed on Aug. 31, 2020.

(51) Int. Cl. E05C 19/18; E05B 13/00; E05B 15/02; E05B 63/00; E05B 67/00

(52) U.S. Cl. CPC E05C 19/182; E05B 13/002; E05B 67/003; E05B 63/0056; E05B 15/0205

(57) ABSTRACT

A door locking apparatus is provided which includes an integrated plate having a strike plate adjoined to an extension, and a lock coupled to a flexible elongate member. The strike plate includes an aperture and fastener holes, and is configured such that it securely affixes to the recess of a door frame when the door is open. The extension is shaped to protrude from the surrounding frame when the strike plate is installed to the frame. The elongate member extends from the extension and is of sufficient length to wrap around a door handle when the door is closed. The lock can pass through the elongate member and an intermediate portion thereof passes through the lock, or, through an opening in the extension such that the door cannot be opened without unlocking the lock and removing it from the elongate member when the elongate member is wrapped around the handle.

### RELATED APPLICATIONS

The present application claims priority to U.S. Provisional Patent Application Ser. No. 63/072,658 filed on Aug. 27, 2021 which is incorporated herein by reference.

### BACKGROUND OF THE INVENTION

The present application relates to door locks. More particularly, the present invention relates to door locks incorporating a temporary strike plate with locking features, and methods of using the same.

During construction of buildings there is often a delay between installation of doors and installation of locks. During the period of delay, there is no convenient way to secure the door. However, it is often desirable to lock certain doors during construction for a variety of reasons.

Moreover, there are many occasions when a portable door lock may be desired. For example, installing locks on doors can be a time-consuming and costly undertaking. In order to avoid time and expenses associated therewith, it may be desirable to install a removable, portable door lock. It may also be desirable to secure a door intermittently or temporarily for short periods of time, and installing a traditional lock under such circumstances may be inconvenient. As a result, it would be advantageous to have removable and reusable lock which can be quickly and easily installed and released, and which permits reasonable unimpeded use of the door.

It is also important for a door lock to be effective and secure. Unfortunately, though portable door locks provide many advantages compared to their fixed lock counterpart, portable door locks suffer from several disadvantages. For example, in order for a portable door lock to meet the aforementioned requirements, many different variations of portable locks have been made, but unfortunately, many of these devices have one or more characteristics which make them unsuitable for universal application. U.S. Pat. Nos. 5,794,871 and 5,501,494 describe a removable portable door lock having an interior member and exterior member adjoined by a connecting strap having a strap locking device. In these patents, the exterior member is placed over an exterior doorknob, the interior is placed on the interior door knob, and the door cannot be opened without forcibly removing the members as they are relatively immovable with respect to one another. Though this embodiment may be cost-effective, practical, and convenient, it fails to provide a lock which provides adequate security and prevents against entry of unauthorized persons.

Additionally, U.S. Pat. No. 6,416,089 discloses a portable door lock installed in a door jam recess that utilizes two plates adjoined by a hinge. Said door lock comprises a plate which extends out from the door frame and has a lock and unlock position. Furthermore, the disclosed portable door lock may include a hook to wrap around a doorknob. This embodiment may be quick and easy for a user to apply, however, it suffers from serious drawbacks. For example, the mechanism which prevents the door from opening can easily be removed and, thus, the door may still be prone to break-ins. Indeed, this disclosure also fails to disclose a portable door lock mechanism which can be installed on a flanged L-shaped handle and, similar to the aforementioned patents, discusses only door knobs which appear spherical in shape.

Besides these, other door lock apparatuses also fail to provide versatile functionality with respect to a door knob or handle design. Specifically, U.S. Pat. No. 4,135,748 describes a removable and reusable door lock which includes a rod-like latching bar and a chain assembly. In particular, the latching bar is bent to approximate a fit for the neck of a door knob. However, given the shape of the bar's bend, the portable door lock is limited in scope with respect to the type of door knob or handle designs with which it is compatible. Furthermore, this locking mechanism fails to utilize an actual lock.

Thus, it would be desirable, therefore, to develop a new apparatus and method for locking doors during construction or the like until a regular lock can be installed, that overcomes these and other limitations of the prior art. Specifically, it would be advantageous to provide a door locking apparatus which is easy to use, secure and cost-effective. It would also be advantageous to provide an apparatus which is removable, reusable, and compatible with handles having levers, L-shaped arms, or flanged ends.

### SUMMARY OF THE INVENTION

The present invention addresses the aforementioned disadvantages by providing an improved door locking apparatus which is removable and reusable, and provides a temporary locking or security measure for a door when an internal locking mechanism is not present or inoperable. The door locking apparatus includes an integrated plate having a door strike plate coupled to an extension. The strike plate may be configured for fastening to a door frame, for example, by having a central rectangular aperture to accommodate the bolt of a lock and a pair of fastener holes. Preferably, when the door is in an open position, the strike plate is attached by a pair of threaded fasteners to the door frame over an empty receptacle for receiving the door bolt once the finished strike plate and related lock components are installed.

In a preferred embodiment, the extension is coupled to the strike plate by being formed of the same steel plate as the strike plate. The locking apparatus may be made of any durable structural material. The extension is shaped for extending past the frame away from an inward-swinging direction or towards an outswing direction of the door hinged to the door frame when the strike plate is fastened to the frame. The extension may include at least one opening in its outer portion for attaching to at least one of a flexible elongate member, to a shackle or lock, or both. The strike plate and extension may be coplanar. Alternatively, the extension and strike plate may be in a parallel configuration, wherein the inner portion of the extension is shaped to provide a perpendicular offset between the strike plate and the outer portion of the extension. Thus, in a preferred embodiment, the parallel offset configuration of the extension, which is fitted to contours of the frame, enables the extension plate to slip between the door and the frame and extend past the frame towards the outside of the inward-swinging door opposite to its direction of swing.

Furthermore, the flexible elongate member is attached to the outer portion of the extension. The elongate member is of sufficient length for wrapping around a door handle when the door is closed. In a preferred embodiment, the flexible elongate member may be, or may include, a cable, for example, a plastic-coated wire rope. In an alternative embodiment, a chain may be used. The flexible elongate member may be configured in a closed loop at a terminus distal from the extension, for attachment to a shackle, lock, or the like. In yet another embodiment, the flexible elongate member may be fastened to the extension by a fastener.

When the apparatus is attached to the frame, the flexible elongate member (e.g., wire rope) can wrap around the handle (also called a knob) which is attached to the door. No lock is installed in the interior of the door. The shackle and/or lock passes through the closed loop formed at the end of the wire rope and an intermediate portion of the wire rope passes through the shackle/lock. Thus, the door cannot be opened without unlocking the shackle/lock or locking mechanism, and removing it from the flexible elongate member.

In accordance with, and without limitation of the foregoing disclosure, a method of locking a door to a frame wherein the door lacks an internal lock may include opening a door hinged to a frame, and attaching a strike plate in a recess of the door frame, wherein the strike plate comprises an extension coupled thereto, and wherein the extension is shaped for extending past the frame of the door and has an flexible elongate member attached to an outer portion of the extension. The method may further include closing the door, wrapping the flexible elongate member around a handle of the door, and locking the proximal terminus of the flexible elongate member to at least one of the extension or to an intermediate portion of the flexible elongate member using a lock. The door may be configured for an internal locking mechanism that latches to the frame. The described apparatus and method are most suitable when the internal locking mechanism is not present or inoperable.

Therefore, it is an object of the invention to provide a door locking apparatus which is easy to install and convenient. Advantageously, the door locking apparatus provides an actual shackle or lock which prevents unwanted entry of unauthorized persons. Also advantageously, the door locking apparatus provides for engagement of the locking components with lever or L-shaped handles having laterally extending flanged arms extending therefrom.

Other features and advantages of the present invention will be appreciated by those skilled in the art upon reading the detailed description which follows with reference to the drawings.

### BRIEF DESCRIPTION OF THE DRAWINGS

FIG. 1 is a plan view of the door locking apparatus illustrating the door strike plate adjoined to the extension, wherein the distal end of the extension has three openings, and wherein the flexible elongate member terminal closed loop of the flexible elongate member is attached to the extension at its opening.

FIG. 2 is a perspective view illustrating the apparatus of FIG. 1 installed in the recess of a door frame and in use for locking a door.

FIG. 3 is a plan view of the door locking apparatus, wherein the proximal end of the extension is shaped to provide an offset between the strike plate and the outer portion of the extension, wherein the offset is perpendicular to the strike plate and the outer portion of the extension such that the strike plate and extension's outer portion are in parallel alignment.

FIG. 4 is a perspective view illustrating the door locking apparatus having an offset, wherein an inch rule is placed in the photo to indicate scale.

FIG. 5 is a perspective view illustrating the door locking apparatus having an offset installed in the recess of a door frame and in use for locking a door.

FIG. 6 is a perspective view showing the door locking apparatus having an offset attached to a door jamb in place of a regular lock, wherein the flexible elongate member is wrapped around the laterally extending flange arm of the L-shaped door handle when the door is closed, thereby locking the door to the frame.

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention, and it is not intended to limit the invention to the specific embodiments illustrated.

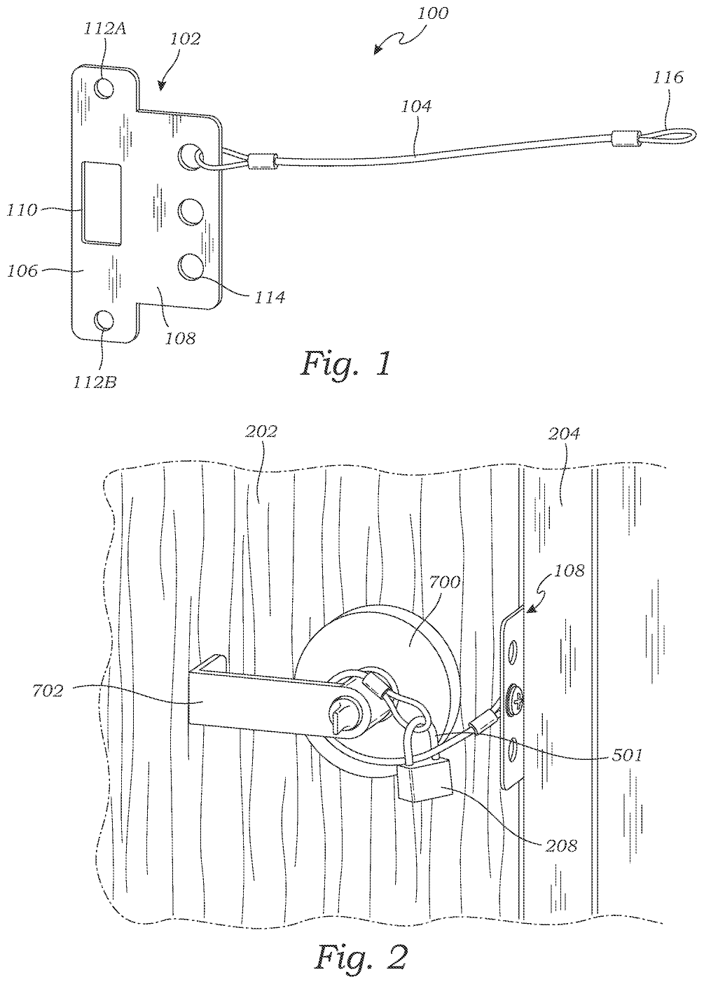

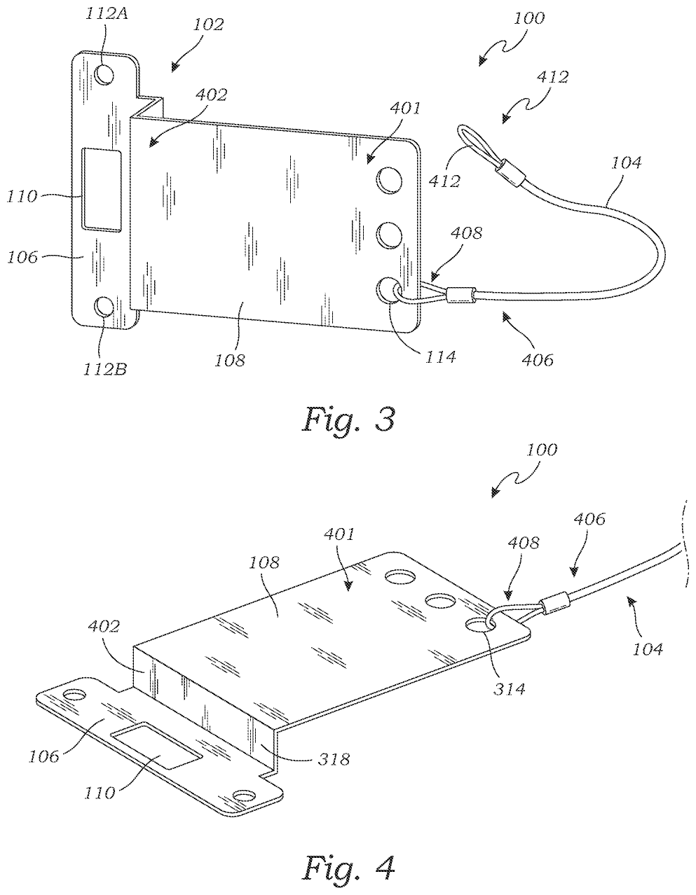

With reference to all FIGS. 1-6, the door locking apparatus 100 for locking a door 202 to a surrounding frame 204 includes an integrated plate 102 having a door strike plate 106 coupled to an extension 108, and a shackle 501 or lock 208 fastened to a flexible elongate member 104. The strike plate 106 portion of the integrated plate 102 is configured so as to fasten to the surrounding door frame 204. Specifically, the door strike plate 106 is sized and configured to attach in the recess 800 of the door frame 204. Preferably, and more specifically, the strike plate 106 includes a central aperture 110 and a pair of fastener holes 112A, 112B. In particular, the central aperture 110 is configured to accommodate the bolt of a lock, and the pair of fastener holes 112A, 112B are configured to further secure the attachment of the strike plate 106 to the door frame 204. As illustrated in FIG. 6, the strike plate 106 and related lock components can be installed to the door frame 204 by threadably affixing a pair of threaded fasteners through the pair of fastener holes 112A, 112B over an empty receptacle 600 for receiving the door bolt. The method of installing the strike plate 106 to the door frame 204 may include opening a door 202 hinged to a frame 204 so as to enable the user to attach the strike plate 106 and its lock components in the recess 800 of the frame 204.

In a preferred embodiment, the central aperture 110 of the strike plate 106 is rectangular in shape. Additionally, the pair of fastener holes 112A, 112B are oriented such that the first fastener hole 112A is arranged proximal to the central aperture 110 and the second fastener hole 112B is arranged distal to the central aperture 110. In the preferred embodiment, the aperture 110 and pair of fastener holes 112A, 112B reside on the same longitudinal axis.

Moreover, the extension 108 portion of the integrated plate 102 includes a inner portion 401 and an outer portion 402, wherein the extension 108 is adjoined to the door strike plate 106 at its inner portion 401. As illustrated in FIG. 1, the dashed line indicates a boundary between the strike plate 106 and the extension 108, and not any physical feature. Furthermore, the strike plate 106 and extension 108 may be integrated together by being formed from the same structural plate and define the integrated plate 102. Preferably, the integrated plate 102 can be made of any durable structural material. Even more preferably, the integrated plate 102 is composed of steel.

The extension 108 is shaped to extend past the surrounding frame 204 towards either an outswing direction or outside of the inward-swinging of the door 202 hinged to the door frame 204 when the strike plate 106 is fastened to the frame 204. In a preferred embodiment, and as illustrated in FIG. 1, the strike plate 106 and the extension 108 are coplanar. In another preferred embodiment, and as illustrated in FIGS. 4-6, the inner portion 401 of the extension 108 is shaped to provide an offset 318 between the strike plate 106 and the outer portion 402 of the extension 108. In this embodiment, the offset 318 may be perpendicular to the strike plate 106 and the outer portion 401 of the extension 108. More particularly, the offset 318 section of the extension 108 is coupled at its edges to the adjoining portions of the integrated plate 102 by complementary bends that are configured to follow the contour of the door frame 204, thereby holding the strike plate 106 and the outer portion 401 of the extension 108 in parallel alignment. Thus, the parallel offset configuration of the extension, which is fitted to contours of the frame 204, enables the extension to slip between the door 202 and the frame 204 and extend past the frame 204 towards the outswing direction or outside of the inward-swinging of the hinged door 202. For example, and as best illustrated in FIG. 6, the parallel offset allows the extension 108 to extend towards the outside of the inward-swinging door 502 opposite to its direction of swing.

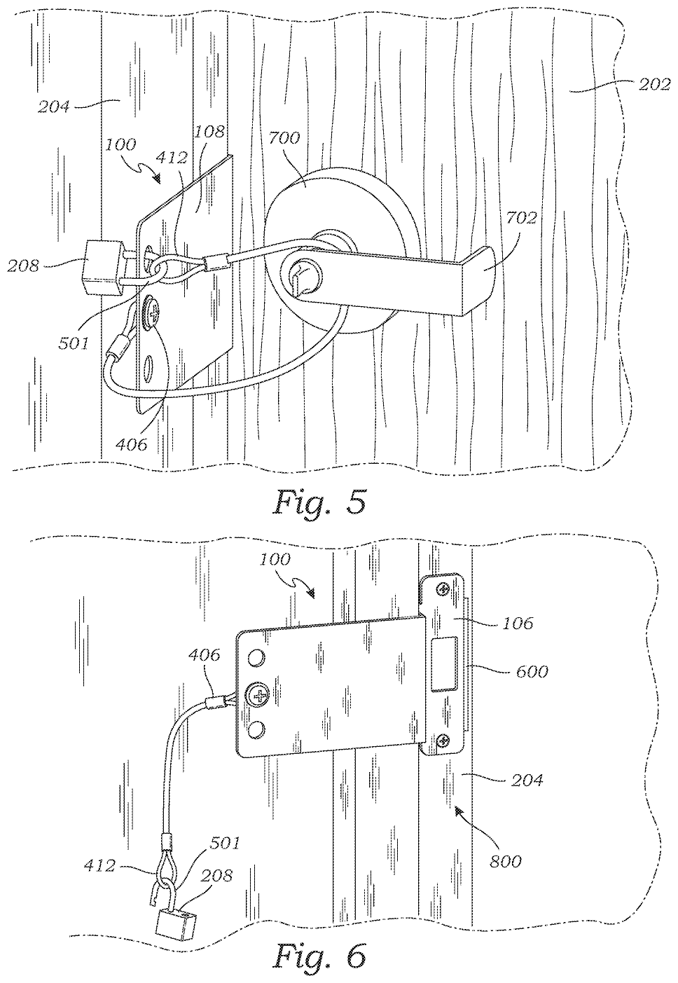

Additionally, at least one flexible elongate member 104 extends from the outer portion 401 of the extension 108. In some embodiments, the outer portion 401 of the extension 108 includes at least one opening 114 for attaching to the flexible elongate member 104 or a shackle 501/lock 208, or both, as illustrated in FIG. 5. Preferably, the flexible elongate member 104 has a proximal terminus 406 having a primary closed loop 408 and distal terminus 410 having a terminal closed loop 412. In particular, the flexible elongate member 104 is configured such that the proximal terminus 406, through its primary closed loop 408, mates with the opening 114 of the extension 108. Alternatively, however, and as illustrated in FIGS. 5-6, the flexible elongate member 104 may be fastened to the opening 114 by a fastener. Further, the flexible elongate member 104 is configured such that the distal terminus 410, through its terminal closed loop 412, engages with a lock 208, shackle 501, or the like. More specifically, the terminal closed loop 412 engages with a shackle 501 on a lock 208. Even more specifically, the shackle 501 of the lock 208 passes through the terminal closed loop 412. In preferred embodiments, the lock 208 may include a padlock, combination lock, digital lock, a single-dial lock, a multiple-dial lock, or a key lock. Additional or alterative lock and shackle constructions can be determined by those skilled in the art.

In a preferred embodiment, the flexible elongate member 104 may be, or may include, a cable. In particular, the flexible elongate member 104 may be a plastic-coated wire rope. Alternatively, in another preferred embodiment, the flexible elongate member 104 may be a chain. Various cable and fastener constructions for providing these capabilities can be selected by those skilled in the art.

Furthermore, the flexible elongate member 104 is of sufficient length to wrap around a handle (or knob) 700 attached to the door 202 when the door 202 is in a closed position. Preferably, the handle 700 is L-shaped or includes a lever with a laterally extending flange 702. Specifically, when the door locking apparatus 100 is installed to the frame 204, the flexible elongate member 104 can wrap around the laterally extending flange 702 of the lever or L-shaped handle 700 when the door 202 is closed and thereby lock the door 202 to the frame 204. More specifically, and as illustrated in FIG. 2, the shackle 501 or lock 208 passes through the terminal closed loop 412 formed at the distal terminus 410 of the flexible elongate member 104 and an intermediate portion of the flexible elongate member 104 passes through the shackle 501 or lock 208. Alternatively, and as best illustrated in FIG. 5, the shackle 501 or lock 208 passes through the terminal closed loop 412 and affixes to an opening 114 in the extension 108. Accordingly, in both scenarios, the door 202 cannot be opened without unlocking the lock 208 and removing it from the flexible elongate member 104.

A door 202 may be configured for an internal locking mechanism that latches to the frame 204. The present door locking apparatus 100 provides an improved door locking apparatus and method of use the locking apparatus is most suitable when the internal locking mechanism is not present or inoperable. Advantageously, the locking apparatus provides a provides a temporary locking or security measure until a conventional lock can be installed in the door, at which time the door locking apparatus 100 can easily be removed and reused. Also advantageously, the door locking apparatus 100 provides a lock which secures the door from unwanted entry of unauthorized persons, and is compatible with door handles having a laterally extending flanged arms.

While a preferred door locking apparatus and methods of use have been illustrated and described, it will be apparent that various modifications can be made without departing from the spirit and scope of the invention. Alternative embodiments may be envisioned by those skilled in the art after consideration of the present disclosure. Accordingly, it will be apparent that various modifications can be made without departing from the spirit and scope of the invention. Therefore, having described my invention in such terms such as to enable a person skilled in the art to understand the invention, recreate the invention and practice it, and having presently identified the presently preferred embodiments thereof, I claim:

1. An apparatus for locking a door to a surrounding frame, the apparatus comprising;
a strike plate configured for fastening to a door frame, wherein the strike plate is sized and dimensioned to attach in a recess of the door frame;
an extension coupled to the strike plate, the extension having a inner portion and an outer portion, wherein the extension is configured such that it adjoins to the extension at its inner portion, the extension shaped for extending past the frame of a door hinged to the door frame when the strike plate is fastened to the frame;
a lock; and
a flexible elongate member configured to extend from the outer portion of the extension, the flexible elongate member having a proximal terminus with a primary closed loop and a distal terminus with a terminal closed loop, wherein the primary closed loop is configured so as to mate with the extension and the terminal closed loop is configured so as to engage with the lock, the flexible elongate member further configured to be of sufficient length for wrapping around a laterally extending flange of a lever door handle when the door is closed so as to lock the distal terminus of the flexible elongate member to at least one of the extension or to an intermediate portion of the flexible elongate member using the lock.

2. The apparatus of claim 1, wherein the strike plate comprises a central aperture and a pair of fastener holes, wherein the central aperture is configured to accommodate a bolt of a door lock, and wherein the pair of fastener holes are configured to secure the attachment of the strike plate to the door frame.

3. The apparatus of claim 1, wherein the extension includes at least one opening in its outer portion for attaching to at least one of the flexible elongate member and the lock.

4. The apparatus of claim 1, wherein the strike plate and the extension are coplanar.

5. The apparatus of claim 1, wherein the strike plate and the outer portion of the extension are parallel, and the inner portion of the extension is shaped to provide an offset between the strike plate and the outer portion of the extension.

6. The apparatus of claim 1, wherein the extension is shaped for extending past the frame towards an outswing direction of the door or away from an inswing direction of the door.

7. A method of locking a door to a door frame wherein the door lacks an internal lock, the method comprising:
opening a door hinged to a door frame;
attaching a strike plate to a recess of the door frame, wherein the strike plate comprises an extension coupled thereto, the extension having a inner portion and an outer portion, the outer portion positioned for adjoining to the strike plate, the extension shaped for extending past the frame of the hinged door after installing the strike plate to the door frame, and a flexible elongate member attached to the outer portion of the extension, the flexible elongate member having a proximal terminus with a primary closed loop and a distal terminus with a terminal closed loop, wherein the primary closed loop is shaped for mating with the extension and the terminal closed loop is shaped for engaging with a lock;
closing the door;
wrapping the flexible elongate member around a laterally extending flange of a lever handle of the door; and
locking the distal terminus of the flexible elongate member to at least one of the extension or to an intermediate portion of the flexible elongate member using the lock.

8. The method of claim 7, wherein the strike plate comprises a central aperture and a pair of fastener holes, wherein the central aperture accommodates a bolt of a door lock, and wherein the pair of fastener holes secure the attachment of the strike plate to the door frame.

9. The method of claim 7, wherein the extension includes at least one opening in its outer portion for attaching to at least one of the flexible elongate member and the lock.

10. The method of claim 7, wherein the strike plate and the extension are coplanar.

11. The method of claim 7, wherein the strike plate and the outer portion of the extension are parallel, and the inner portion of the extension is shaped to provide an offset between the strike plate and the outer portion of the extension.

12. The method of claim 7, wherein the extension is shaped for extending past the frame towards an outswing direction of the door or away from an inswing direction of the door.

13. A door locking assembly comprising:
a door frame having a recess;
a door hinged to the door frame, wherein the door lacks an internal lock;
a lever handle extending from the door, the lever handle having a laterally extending flange extending therefrom;
a strike plate fastened to the recess of a door frame;
an extension coupled to the strike plate, the extension having a inner portion and an outer portion, wherein the extension adjoins to the extension at its inner portion and extends past the door frame of the door;
a lock; and
a flexible elongate member which extends from the outer portion of the extension, the flexible elongate member having a proximal terminus with a primary closed loop and a distal terminus with a terminal closed loop, wherein the primary closed loop mate with the extension, wherein the terminal closed loop engages with the lock, and wherein the flexible elongate member wraps around the laterally extending flange of the lever handle when the door is closed and locks the distal terminus of the flexible elongate member to at least one of the extension or to an intermediate portion of the flexible elongate member using the lock.

14. The assembly of claim 13, wherein the strike plate comprises a central aperture and a pair of fastener holes, wherein the central aperture accommodates a bolt of a door lock, and wherein the pair of fastener holes secure the attachment of the strike plate to the door frame.

15. The assembly of claim 13, wherein the extension includes at least one opening in its outer portion which attaches to at least one of the flexible elongate member and the lock.

16. The assembly of claim 13, wherein the flexible elongate member is fastened to the extension by a fastener.

17. The assembly of claim 13, wherein the strike plate and the extension are formed from the same structural plate and define an integrated plate.

18. The assembly of claim 13, wherein the strike plate and the extension are coplanar.

19. The assembly of claim 13, wherein the strike plate and the outer portion of the extension are parallel, and the inner portion of the extension provides an offset between the strike plate and the outer portion of the extension.

20. The assembly of claim 13, wherein the extension extends past the frame towards an outswing direction of the door or away from an inswing direction of the door.
